(19) United States
(12) Patent Application Publication
(10) Pub. No.: US 2018/0039742 A1
(43) Pub. Date: Feb. 8, 2018

(54) SYSTEM FOR SCHEDULING HEALTHCARE APPOINTMENTS BASED ON PATIENT NO-SHOW PROBABILITIES

(71) Applicant: KONINKLIJKE PHILIPS N.V., EINDHOVEN (NL)

(72) Inventors: Xiang Zhong, Briarcliff Manor, NY (US); Jingyu Zhang, Elmsford, NY (US); Zhichao Shu, Briarcliff Manor, NY (US)

(21) Appl. No.: 15/551,296

(22) PCT Filed: Feb. 17, 2016
(86) PCT No.: PCT/IB2016/050835

§ 371 Date: Aug. 16, 2017

Related U.S. Application Data
(60) Provisional application No. 62/121,583, filed on Feb. 27, 2015.

(51) Int. Cl. G06F 19/00; G06Q 50/22; G06Q 10/10

(52) U.S. Cl. CPC G06F 19/327; G06Q 10/1095; G06Q 50/22; G06N 5/04

(57) ABSTRACT

A patient appointment schedule is generated for an open access time window (typically a single day). A no show likelihood is assigned for each time slot based on past patient no show (missed appointment) information, and time slots whose no show likelihood exceeds a threshold are designated as open access time slots. The patient appointment schedule is displayed. During scheduling, an unfilled time slot may be allocated to a patient so as to be converted to a filled time slot, or conversely a filled time slot may be deallocated so that the filled time slot is converted to an unfilled time slot. However, unfilled open access time slots are allocated to patients only during the open access time window, so as to accommodate patients who should be seen on the same day they call.

### FIELD

The following relates generally to systems and methods for creating and adjusting a computerized patient scheduling system. It finds particular application in system to alleviate the burden of patients that do not show for an appointment or rescheduling last minute cancellations and will be described with particular reference thereto. However, it is to be understood that it also finds application in other usage scenarios and is not necessarily limited to the aforementioned application.

### BACKGROUND

A scheduling tool should benefit both patients and providers. The panacea to the acute needs is a medical appointment scheduling system offering same-day appointments. Open access scheduling, also referred to by similar nomenclatures such as advanced access scheduling or same-day scheduling, endeavors to provide same-day appointments for (ideally) all patients who call for an appointment. Open access scheduling recognizes that the traditional approach of scheduling patient appointments days or weeks into the future is detrimental to both patient and doctor. The patient is forced to wait until the scheduled future appointment, possibly suffering pain, discomfort, or condition deterioration in the interim. The doctor is harmed because, in effect, the doctor is procrastinating by putting off until the future patient visits that (ideally) should be handled today.

Switching a doctor's office or other medical care practice from traditional scheduling to open access is a complicated process. Practices must staff according to patient demand in order to handle all calls on that day. This requires a practice to predict how many patients will call on a given day, including accounting for seasonal and other variations. An inappropriately designed patient appointment system will lead to either staff overworking or being unnecessarily idle. During the transition, physicians may need to work harder for months to get through the backlog of patients before open access (e.g. same-day or next-day) scheduling can start in earnest. Therefore, balancing the supply and demand is critical.

Another challenge for outpatient health care providers the commonly high number of patients who fail to show up for their appointments, which results in wasted time and money. Attempts to reduces such “no shows” include charging for the office visit if no (or insufficient) notice is given, e.g. the patient must call 24 hours in advance to reschedule or the office visit will be charged. However, this “solution” is unsatisfactory because it can result in possibly losing the patient who is annoyed at paying for the missed appointment, results in needing to schedule a new appointment for the patient, and of course the “no show” patient's treatment is delayed. Another approach is to employ a manual and/or automated reminder service, such as having the practice receptionist telephone each patient a day before the appointment to provide a reminder, or sending a reminder email or text message, or so forth. These approaches are laborious if manually performed, can be expensive if a third party is contracted to send out the reminders, can annoy the diligent patient who actually plans to arrive on time, and the patient may still forget the appointment even after receiving the reminder. Moreover, the “no show” may not be due to forgetting the appointment, but rather may be due to being too busy and consciously electing at the last minute to skip the appointment. Thus, there is a pressing demand for a customized open-access scheduling system which accommodates both providers and patients' specific needs.

To reduce the impact of transitioning to open access scheduling, some health care providers use a gradual “small tests of change” to iteratively improve their practices. However, when contemplating major changes in systems of care, such as patient scheduling system, prevailing tools like a plan-do-check-act (PDCA) model is not appropriate, and randomized controlled trials are usually not feasible and are disliked by physicians.

Another approach is the so-called “first come, first served” approach, in which no appointment is scheduled at all, and patients are seen in the order in which they arrive. However, such an unscheduled open-access approach can lead to long waiting periods, and patients tend to arrive early in an effort to be seen first, commonly leading to a morning rush with long patient waits followed by an empty late morning or late afternoon schedule. Unscheduled access also is unable to prioritize patients and introduce delays where appropriate (for example, a patient who wants to obtain his or her annual physical examination is unlikely to want same-day service, and may well prefer to schedule the physical for a date-certain that may be days or weeks in the future). Open access scheduling endeavors to provide the benefits of the “first come, first served” approach (e.g. same-day doctor visits) while also retaining the benefits of maintaining a predetermined schedule designed to distribute the workload over the day.

The following discloses improved systems and methods that overcome the above deficiencies and others.

### SUMMARY

In accordance with one aspect, a medical appointment scheduling system is disclosed. A database stores past patient visit log data including at least past patient appointment date and time, and past patient visit outcome information. The stored past patient visit outcome information is at least sufficient to determine whether the past patient was a no show. One or more electronic processors are programmed to generate a patient appointment schedule for an open access time window. The patient appointment schedule comprises time slots, and the generating includes (1) assigning a no show likelihood for each time slot based on patient no show information retrieved from the database, and (2) designating time slots whose no show likelihood exceeds a threshold as open access time slots. A user interface system is provided, including a display device and at least one user input device. The user interface system is configured to: display the patient appointment schedule; allocate an unfilled time slot to a patient whereby the unfilled time slot is converted to a filled time slot; and deallocate a filled time slot whereby the filled time slot is converted to an unfilled time slot. The user interface system is configured to allocate an unfilled open access time slot to a patient only during the open access time window for which the patient appointment schedule is generated.

In accordance with another aspect a non-transitory storage medium stores instructions readable and executable by an electronic processor to perform medical appointment scheduling operations including: generating a patient appointment schedule comprising time slots for an open access time window including designating some time slots as open access time slots; causing a display device to display the patient appointment schedule including displaying an indication of which time slots are designated as open access time slots; allocating an unfilled time slot to a patient whereby the unfilled time slot is converted to a filled time slot; and deallocating a filled time slot whereby the filled time slot is converted to an unfilled time slot. The allocating is operative for the open access time slots only during the open access time window.

In accordance with another aspect, a method is disclosed for creating a customized appointment scheduling plan with same day appointments available. The method includes: receiving inputs at an electronic processor related to one or more scheduling preferences and historical patient visit data; generating an appointment template based upon the one or more scheduling preferences; optimizing the appointment templates based upon the past patient visit data; creating an optimal schedule; and displaying the optimal schedule. The generating, optimizing, and creating are suitably performed by the electronic processor.

One advantage resides in offering social services to a patient.

Another advantage resides in finding locally available social services to a patient.

Another advantage resides in finding a balance between medical treatments and social service treatments.

Another advantage resides in reducing staffing costs while optimizing treatment for a patient.

Still further advantages of the present invention will be appreciated to those of ordinary skill in the art upon reading and understand the following detailed description. It is to be appreciated that none, one, two, or more of these advantages may be achieved by a particular embodiment.

### BRIEF DESCRIPTION OF THE DRAWINGS

The disclosure may take form in various components and arrangements of components, and in various steps and arrangement of steps. The drawings are only for purposes of illustrating the preferred embodiments and are not to be construed as limiting the invention.

FIG. 1 illustrates a block diagram of an open-access patient scheduling system in the context of a serviced medical facility.

FIG. 2 diagrammatically illustrates a flowchart overview of the open-access scheduling system of FIG. 1.

FIG. 3 illustrates an example provider schedule input interface.

FIG. 4 illustrates an example clinic log data.

FIG. 5 illustrates an example appointment template (i.e. optimized patient appointment schedule).

FIG. 6 illustrates an example simulation model using the input from the medical facility.

FIGS. 7-9 diagrammatically show some suitable simulation result presentation formats.

### DETAILED DESCRIPTION

The following discloses a customized scheduling system for clinic or hospitals for use in scheduled patient visits with same-day appointments offered to achieve optimized health care practice. This automated electronic scheduling software can help office staff track and analyze no show trends within their practice. In addition, the system can assist in determining the most effective method for managing appointment templates. By streamlining the appointment making process, patients face fewer annoyances they could face when calling to schedule appointments—long hold times, back-and-forth determination of suitable appointments, and lengthy explanations of chief complaints and contact information.

Disclosed herein are improved hospital and clinic patient scheduling systems designed to accommodate both provider and patient's specific needs and account for uncertainties in day to day scheduling. The present disclosure creates a tailored integrated scheduling plan to optimize patient scheduling within a clinic or hospital setting. Advantageously, the systems and methods of the present disclosure provide a processor that: (1) integrates a physician's schedule and preferences; (2) a hospital or clinic data log that provides historic data for past patient visits; (3) an appointment template generation module to construct a template pool; (4) an advanced optimizer module for simulation optimization to evaluate the healthcare delivery system performance and elect the optimal appointment template; and (5) optimal templates and system performance output and feedback interface.

The disclosed medical appointment scheduling systems and methods provide open access scheduling, while still allowing patients to be conventionally scheduled, i.e. scheduled for appointments at some significant distance in the future. As used herein, the term “open access” designates that the scheduling system provides a patient appointment schedule for an open access time window (usually a single day. although some other relatively short open access time window such as a two-day open access time window may be used) that includes a mechanism to facilitate scheduling patients during the open access time window. The mechanism includes designating some time slots (e.g., those that are likely to have no shows) as open access time slots, and only allowing those open access time slots to be filled (i.e. allocated to patients) during the open access time window. Time slots that are not designated as open access time slots can be filled anytime. This provides a principled mechanism to schedule patients on a same-day basis in a way that does not produce long patient waits or overwork for the doctor. While same-day appointments are usually the goal in open access scheduling, so that the open access time window is typically one day, in some embodiments the open access time window may different from this, for example two days.

A difficulty with designating certain time slots of the patient appointment schedule as open access time slots is that they cannot be filled before the open access window starts. This could result in the open access time slots not being filled. In a variant embodiment, each open access time slot is duplicated, with the duplicate time slot not being designated as an open access time slot. In this way, the time interval occupied by each open access time slot can be double-booked by two patients, one of which is allocated to the open access time slot during the open access time window and the other of which can be allocated anytime. This does raise the possibility of overbooking—however, if the open access time slots are chosen to be time slots having a high probability of no shows, then such overbooking is likely to be limited, and the difficulties produced by the double booking may be outweighed by the benefit of having fewer time slots not filled at all.

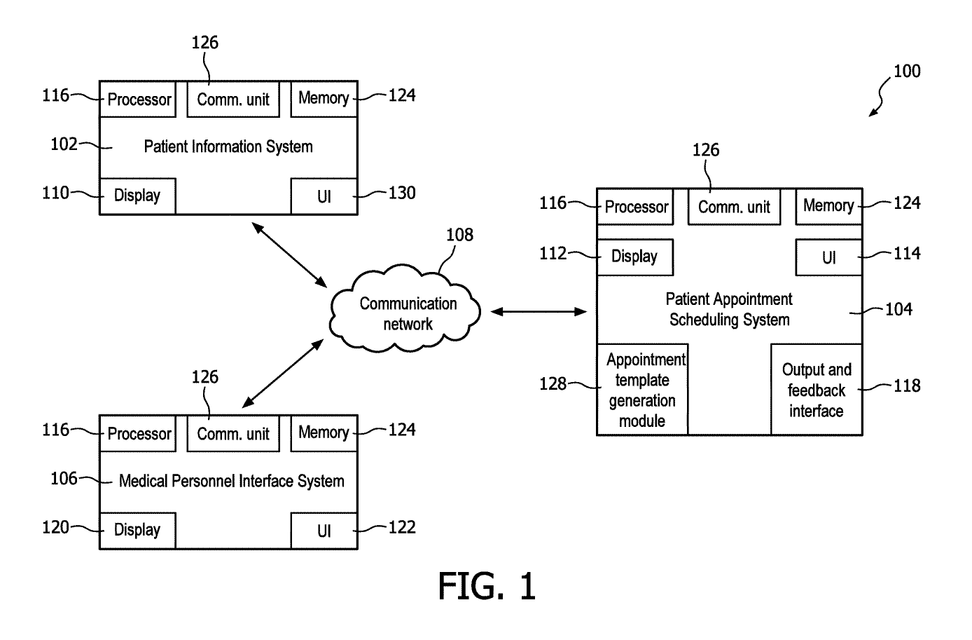

With reference to FIG. 1, a block diagram illustrates one embodiment of a medical facility 100, such as a hospital. The medical facility 100 suitably includes a patient information system 102, a patient appointment scheduling system 104, and a medical personnel interface system 106 and the like, interconnected via a communications network 108. It is contemplated that the communications network 108 includes one or more of the Internet, Intranet, a local area network, a wide area network, a wireless network, a wired network, a cellular network, a data bus, and the like. It should also be appreciated that the various components of the medical facility 100 may be located at a central location or at multiple remote locations. It will be appreciated that the medical facility 100 may be an individual doctor's office, a small specialty or general practice medical group supporting a small number of doctors or specialists, a larger medical institution such as a hospital or hospital network, or so forth.

The patient information system 102 stores patient data related to one or more patients being treated by the medical facility 100. The patient data includes log data from a hospital or clinic registry storing historical data of past patient visits. The patient information system 102 includes a display 110 (such as a CRT display, a liquid crystal display, a light emitting diode display, and the like) to display the clinical models and algorithms and a user input device 114 such as a keyboard and a mouse, for the clinician to input and/or modify the clinical models and algorithms. The patient information system 102 may, for example, be an office productivity suite (possibly medical practice-specific), a hospital admissions management system, or so forth.

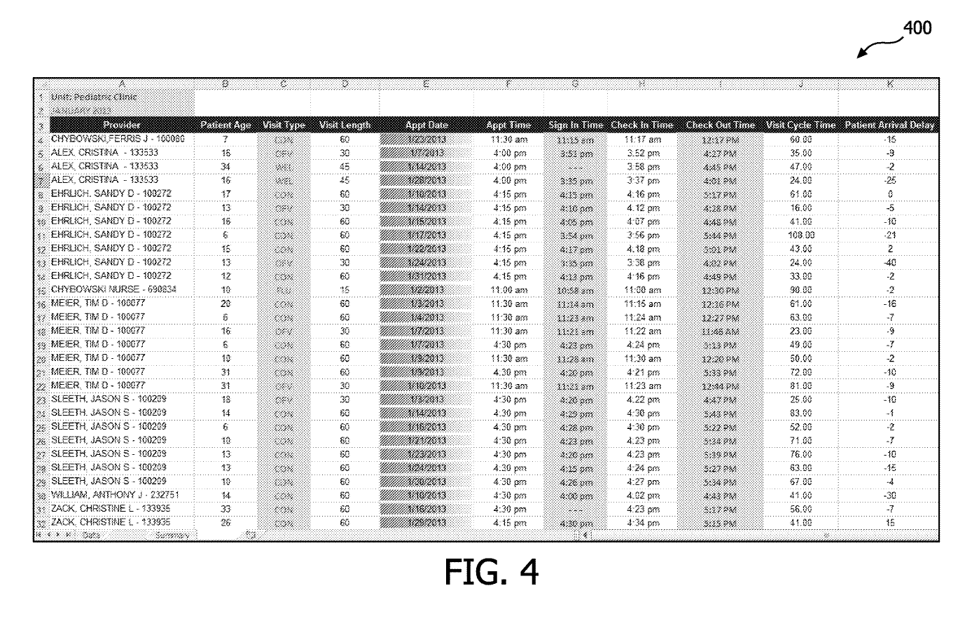

With further reference to FIG. 4, an example appointment template is described as generated from the appointment template generation module 128. A predictive model is built using the historical data related to patient scheduling. Those data possesses information of past appointments (workday, time, appointment type, appointment length, provider, etc.) and the outcomes whether the patient is on-time, arrive in advance, late, no-show or cancellation, or the slot is unscheduled (appointment vacancy), etc. To build and validate the model, data is divided two-fold, one for training the predictive model and one for testing the model performance. The classification model to be used may depend upon the data, for example regression tree classification, random forest, SVM, boosting, and multinomial logistic regression may be used. Using multinomial logistic regression, a model is developed using a linear predictor function ƒ(k,i) to predict the probability that patient i has outcome k of the following form:

ƒ(k,i)=β_{0,k}+β_{1,k}x_{1,i}+β_{2,k}x_{2,i}+ . . . +β_{M,k}x_{M,i},

where x_{m,i} is the m^{th} explanatory variable (i.e. patient visit feature), β_{m,k} is the regression coefficient associated with the m^{th} explanatory variable (feature) and the k^{th} outcome. The explanatory visit features are selected from patient i's general appointment information. For example, x_{1,i} can be the workday, which is a categorical feature taking a value from the set of feature values {Monday, Tuesday, Wednesday, Thursday, Friday, Saturday and Sunday}. Similarly, x_{2,i} can be the appointment type, which describes whether patient is scheduled for an office visit (OFV), a long office visit (LOV), a consultation (CON), a physical assessment (PHY), etc. The outcomes include K possibilities. For instance, patient does not show-up, patient arrives on-time, patient shows-up but not on-time, patient cancels in advance, and K=4 in this case. For characterizing no shows, these several outcomes can be simplified into a logistic regression with a binary outcome, i.e., whether patient shows-up or not (i.e. a binary show/no show outcome).

Further, the model can be written in a vector notation as ƒ(k,i)=βₖXᵢ where βₖ is the set of regression coefficients associated with outcome k, and Xᵢ is the set of explanatory variables associated with patient i. With the predictive model, the probability for each outcome category can be achieved:

$$Pr ( {Y}_{i} = c ) = \frac{{e}^{{β}_{c} {X}_{i}}}{1 + {\sum }_{k = 1}^{K - 1} {e}^{{β}_{k} {X}_{i}}} , c = 1 , 2 , … , K - 1 , \\ or Pr ( {Y}_{i} = 1 ) = \frac{{e}^{{β}_{1} {X}_{i}}}{1 + {e}^{{β}_{1} {X}_{i}}}$$

where 1 indicates that patient will not show-up in the logistic regression model.

The prediction outcome can be used for generating appointment templates in addition to physician's schedule information. The time slots which are booked in advance but suffered from high patient no-show rates can be designated as open-access time slots. In one approach for designating the open access time slots of the patient appointment schedule, the no-show probability estimated by the predictive model is compared with a threshold (denoted as p) to decide whether to designate a time slot as an open-access time slot. This threshold p is also used as a tuning parameter while conducting simulation optimization. In addition, the predictive model assists in characterizing patient arrival behavior for simulation purpose.

By taking into account the physician's schedule and preference and the outcome of the predictive model, a pool of candidate templates is obtained. Customized daily/weekly appointment templates are generated for each provider with detailed appointment slots arrangement.

The patient appointment scheduling system 104 includes an appointment template generation module 128 and an output and feedback interface 118. The appointment template generation module 128 creates candidate templates. It considers the inputs from the physicians and the outcomes from the predictive model, feasible templates are generated and stored for further assessment. An optimizer builds a discrete event simulation model to simulate the healthcare delivery system and to assess the performance of candidate templates. System performance such as physician and other staff's utilization, physician and other staff's working overtime, and patient's waiting time and length of stay can be evaluated. The optimization objectives are to maximize physician and other staff's utilization, minimize physician and other staff's working overtime, and minimize patient's waiting time and length of stay. The simulation-optimization methods are utilized to identify the optimal template and system setting. After receiving patient data, the patient visit scheduling system 104 applies the clinical model and algorithm to scheduling the patient and generates medical data including one or more appointment templates including scheduling slots. The patient visit scheduling system 104 includes a display 112 (such as a CRT display, a liquid crystal display, a light emitting diode display, and the like) to display the clinical models and algorithms and a user input device 114 such as a keyboard and a mouse, for the clinician to input and/or modify the clinical models and algorithms. The patient visit scheduling system 104 further includes an appointment template generation module 128 and an output and feedback interface 118, as described in more detail below.

The appointment template generation module 128 yields candidate templates. It considers the inputs from the physicians and, as a result feasible templates are generated and stored for further assessment. The appointment template generation module 128 also includes an optimizer generating optimal appointment template for featured healthcare delivery system. A discrete event simulation model is built to simulate the healthcare delivery system as to assess the performance of candidate templates. System performance such as physician and other staff's utilization, physician and other staff's working overtime, and patient's waiting time and length of stay can be evaluated. The optimization objectives are to maximize physician and other staff's utilization, minimize physician and other staff's working overtime, and minimize patient's waiting time and length of stay. Simulation-optimization methods are utilized to identify the optimal template and system setting.

The output and feedback interface 118 allows physicians to view the optimal appointment template, as well as the corresponding system performances and settings, including number of patients they are expected to see per workday/week, a patient waiting time, length of stay on average, physicians and other staff's occupancy and potential working overtime.

The medical personnel interface system 106 enables the user (e.g. a doctor, nurse, or the like) to input their schedules including their workdays, shifts, starting time and working hours by workday, whether they need to work with other medical personnel (residents or nurses, et cetera), and other constraints and preferences if any is included. The information is optionally used to set up constraints when generating tentative appointments.

The medical personnel interface system 106 includes a display 120 (such as a CRT display, a liquid crystal display, a light emitting diode display, and the like) to display the evaluation and/or comparison of choices and a user input device 122 such as a keyboard and a mouse, for the user to input the patient values and preferences and/or modify the evaluation and/or comparison. Examples of medical personnel interface systems 106 include, but are not limited to, a software application that could be accessed and/or displayed on a personal computer, web-based applications, tablets, mobile devices, cellular phones, and the like.

The components of the open-access patient scheduling system 104 suitably include one or more electronic processors 116, e.g. a computer or the like, executing computer executable instructions embodying the foregoing functionality, where the computer executable instructions are stored on memories 124 associated with the processors 116. Further, the components of open-access patient scheduling system 104 include communication units 126 providing the processors 116 an interface from which to communicate over the communications network 108. Even more, although the foregoing components of the open-access patient scheduling system 100 were discretely described, it is to be appreciated that the components can be combined. It will also be appreciated that the open access patient scheduling system 104 can be embodied as a non-transitory storage medium storing instructions readable and executable by an electronic processor 116 (e.g. computer) to perform the disclosed scheduling operations. The non-transitory storage medium may, for example, be a hard disk drive or other magnetic storage medium, an optical disk or other optical storage medium, a (erasable, programmable, etc.) read-only-memory (ROM), flash memory, or other electronic storage medium, or so forth.

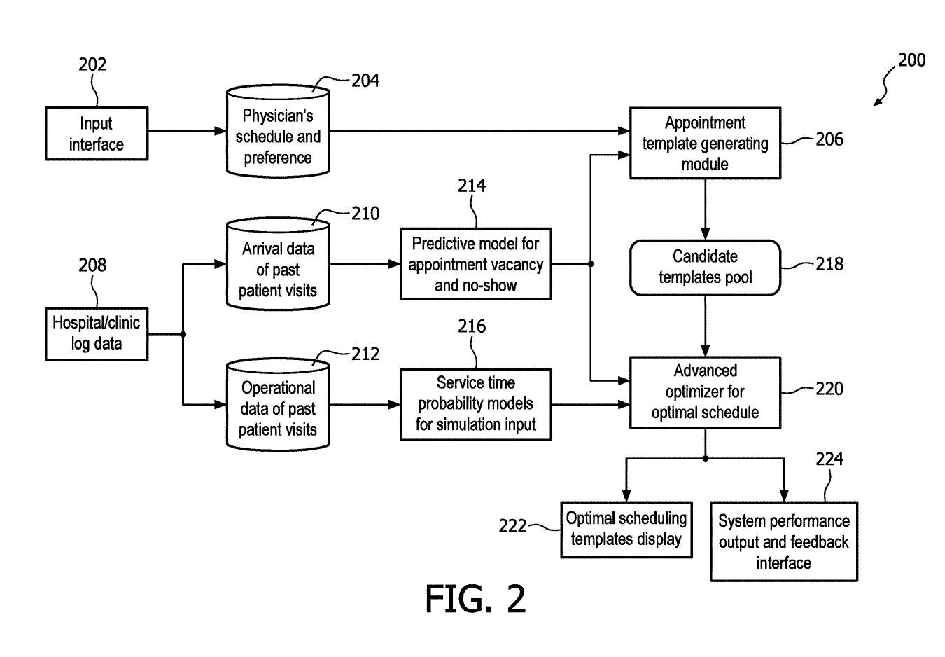

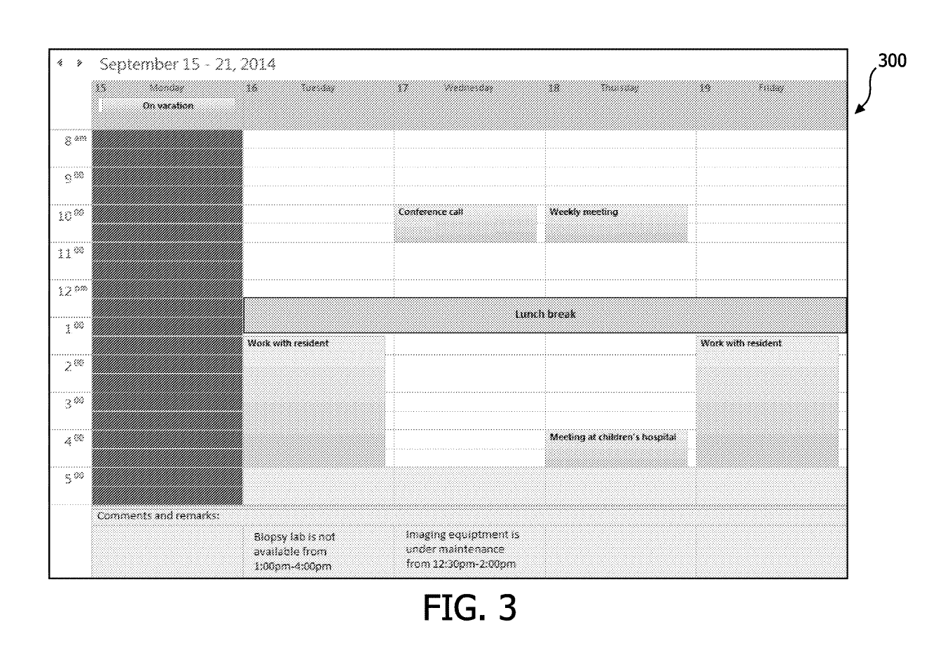

With reference to FIG. 2, a flowchart overview 200 of a suitable embodiment of the open-access scheduling system 104 is described. Upon creation of a new appointment scheduling template, a user, such as a physician, accesses an input interface and inputs data regarding his or her schedule 202 such as described in further detail in FIG. 3. This information allows the appointment template generation module to take into account user preferences and not allow for scheduling during unavailable time slots. This information is stored in the physician's schedule and preference database, 204. The system also takes into account hospital or clinic historical (i.e. past) patient visit log data. The past patient visit log data is shown and described in more detail in FIG. 4. The past patient visit log data should include at least past patient appointment date and time, and past patient visit outcome information wherein the past patient visit outcome information is at least sufficient to determine whether the past patient was a no show. Other information may be included, such as information on medical resources spent on the past patient visit, e.g. medical personnel time spent on the past patient visit. As further referenced in FIG. 4, an example clinic log data sheet 400 is described. With respect to the log data from hospital/clinic registry described above in FIG. 1, two databases are created to store and pre-process the raw data obtained from the hospital/clinic log data. Patient log data (optionally anonymized) are collected and organized via database management software like SQL, MySQL, etc. Patients' past visit information 210 such as scheduled arrival time, real arrival time, or whether it is a cancellation or no-show, and the visit type, visit length, provider information, etc., are extracted to train the predictive model. Operational data 212 like time stamps of patient checks-in, nurse finishes rooming, physician diagnoses and lab test, discharge etc., are obtained to generate the healthcare delivery system simulation model input. Detailed patients visit information including patient age, visit type, visit length, appointment date, appointment time, registration time, check-in time, check-out time and visit cycle time, etc., for different providers are recorded.

The patient arrival time is utilized by a predictive module 214 that takes into account the historic data for a general patient population to determine trends in vacancies, no-shows and late cancellations. The predictive module information is used by the appointment template module 206 and the template optimizer 220. The operational data of historical patient visits takes into account the different types of appointments offered and their usual length of visits. This allows the appointment template generator to properly schedule various visits such that a same-day appointment can only be scheduled if it fits within the available blank spots. This information is utilized by the appointment template optimizer 220.

Upon receipt of a user's preferences and schedules 204, and the predictive module data, the appointment template generator 206 determines a set of candidate templates 218 for the user to review. At this point, the user can choose one of the candidate templates 218, or the optimizer 220 can review the candidate templates 218 and, using information from the operation data module 212, provide a more detailed and better fit appointment template for the specific office/clinic setting. The scheduling optimizer 220 provides an optimal scheduling template 222 taking into account all relevant information and provides a system performance output from the output and feedback module 224. This information allows a user to review parameters taken into account for a given template such as the number of patient's a physician is expected to see each day or week, or the number of staff members that will be required to staff the schedule.

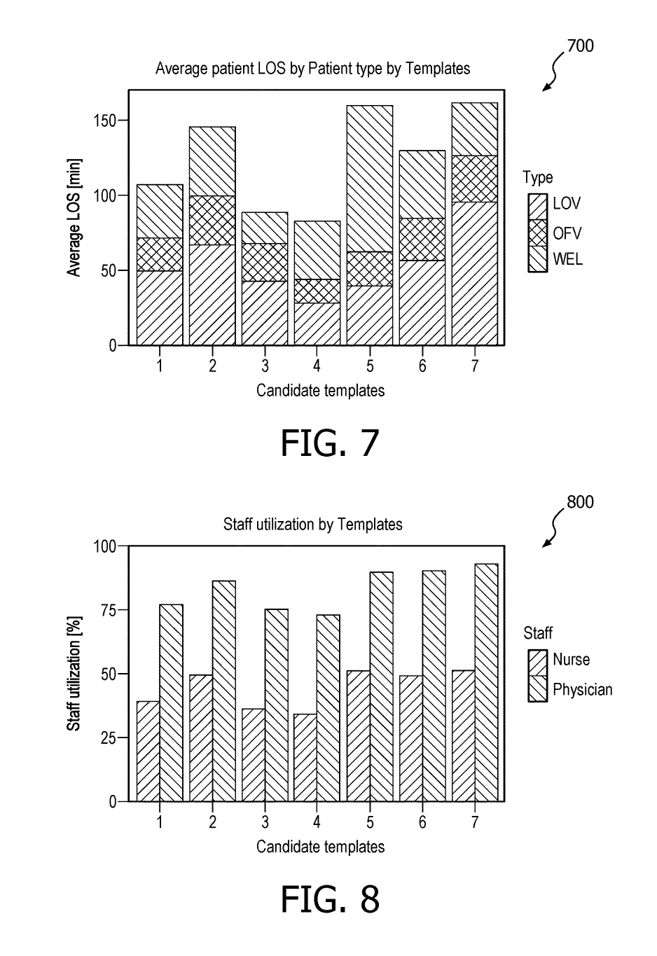

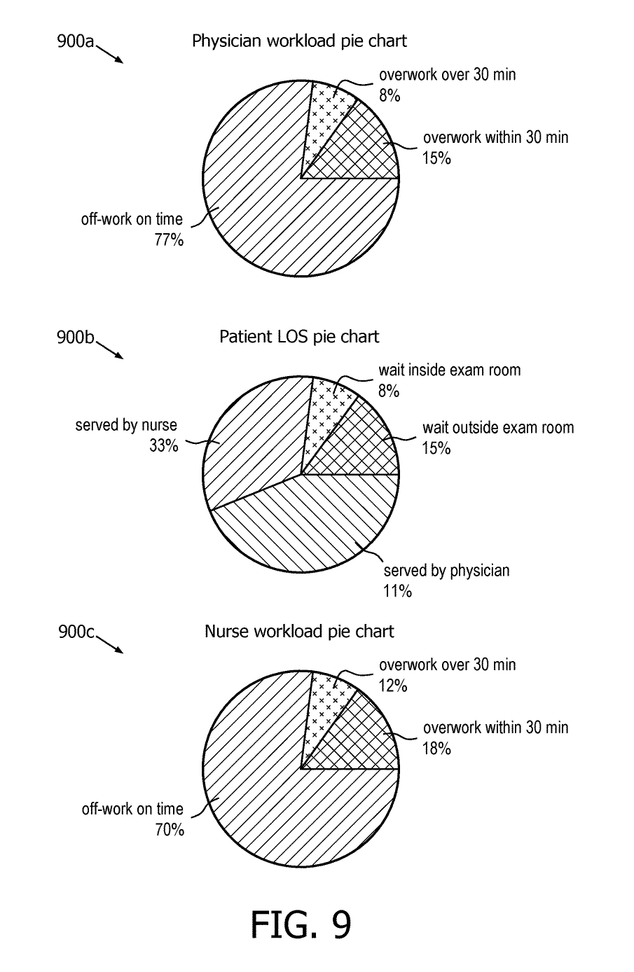

The output and feedback interface provides a visualization of the optimization results. Specifically, the system performances corresponding to different appointment templates and system settings are compared using figures, charts and tables. FIGS. 7 and 8 show a bar chart illustrating the average patient length of stay by patient type by template 700 and the staff utilization by staff type by template 800, which are among the multiple objectives to be optimized, i.e., the shorter the patient length of stay and the higher the staff utilization are preferred. In addition, FIG. 9 illustrates various physician and nurse's workload distribution and the composition of patient's length of stay under a certain system setting using a certain template 900a, 900b, 900c. These detailed system performances will assist physician and office staff in making decisions. For example, less working overtime and less waiting during stay would be preferred, but might not be achieved simultaneously. Based on these results, physicians or office staff should be able to decide which templates are most suitable under different system settings.

As shown in FIG. 3, an example physician interface input 300 is shown. The physician's input interface is typically a web application which allows physicians to update their calendars and working schedules. The application provides a friendly and convenient user interface. Physicians can opt-in for synchronizing their schedules from standardized general-purpose scheduling software such as Google calendar or Microsoft Outlook automatically, or manually add or change their schedules. The detailed input includes working schedule such as number of working shifts per each workday, time to start and time to end; options like working with resident/nurse or not; constraints like special appointments, meetings and conferences, and other constraints like vacations or sick leaves if any, and comments and remarks.

For example, FIG. 3 shows a sample provider's weekly calendar from September 15 to 19 (workdays). Physician starts working at 8:00 am in the morning and finishes work at 5:00 pm if no working overtime. There is a lunch break during 12:30-1:30 pm for each workday. The physician is on vacation this Monday (September 15). No appointment can be scheduled during that day. From Tuesday to Friday the physician is available except for several slots which are scheduled for meetings and conferences formerly, and patients' appointments will be adjusted accordingly. In addition, the physician will work with a resident on Tuesday and Friday, and the length of slots might be extended for the present of the resident. Besides, other constraints like the availability of clinic/hospital facilities and equipment might also affect the appointments for certain types of patients. These are marked below the corresponding dates. Notifications will pop-up to remind physicians to update their schedules weekly or monthly.

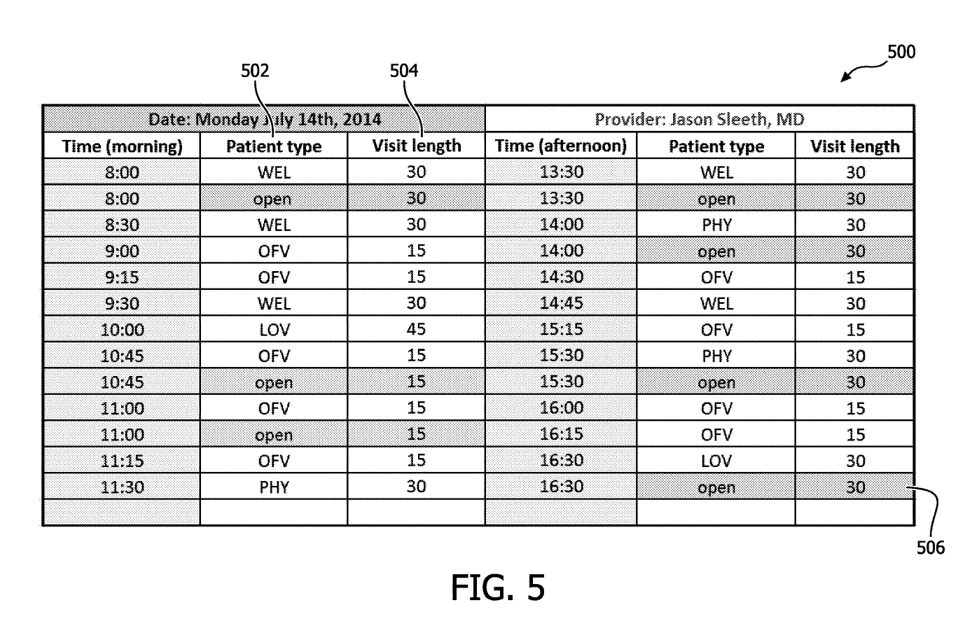

With further reference to FIG. 5, an optimized scheduling template (i.e. optimized patient appointment schedule) 500 showing time slots for various scheduled patient appointments, the type of appointment 502, and the length of each expected appointment 504. Some time slots are designated as open access time slots 506. The open access time slots allow for same day appointment requests to be fulfilled. For example, in FIG. 5, the physician will start his Monday morning shift at 8:00 am to receive the first patient, and has a lunch break during 12:00-1:30 pm. His afternoon shift starts at 1:30 pm and ends at 5:00 pm. The types of patients the physician sees include office visit (OFV), long office visit (LOV), physical (PHY) and well child check (WEL) as being a pediatrician. The visit lengths are 15 min, 45 min, 30 min, and 30 min, for OFV, LOV, PHY, WEL, correspondingly. If the template is fully booked, there will be 26 patients seen by the provider as the maximum capacity—but this upper limit is unlikely to be reached in practice as some time slots may not be filled, and/or some scheduled patients may be no shows. The total number of slots is decided by combining the estimated patient demands and the appointment vacancy as observed from the patient's arrival history. Specifically, in this case, patients are less likely to show-up in the early Monday morning, thus an open-access slot is arranged. Slots which are seldom booked in advance can be set as open-access slots for same-day appointments as well. To achieve this, for each slot the probability of patient not showing up is estimated using the predictive model. Then by comparing with the probability threshold p, a decision rule can be made. For example, let p=0.75, those slots with a vacancy probability larger than 0.75 will be set as open-access slots. The value of p is subject to change to obtain the best system performance under different system settings. Besides, the order of the visits can be altered. Different types of patient visits can be blocked by type or alternatively assigned according to visit length, or randomly arranged. Accounting for those options, a pool of feasible templates is generated for further analysis. Moreover, the templates are not fixed. The system allows dynamically reassigning open-access slots to accommodate patient's cancellation in advance. If patient cancels the appointment before the scheduled time, that slot will be switched to an open-access slot or reserved to smooth the workflow depends on daily operation status.

In FIG. 5, it will be noticed that each time slot that is designated as an open access time slot (that is, each open access time slot 506) has a duplicate time slot that is not designated as an open access time slot. For example, the 8:00 am time slot designated as an open access time slot, and there is also a duplicate 8:00 am time slot that is not designated as an open access time slot. This approach of duplicating each open access time slot in the patient appointment schedule 500 advantageously tends to maximize bookings, but at the possible cost of overbooking leading to increased patient waiting times and more work for the doctor. In practice, if (as disclosed herein) the open access time slots are chosen to be time slots that are most likely to have no shows, then the likelihood of two patients being booked in the same time slot is minimized.

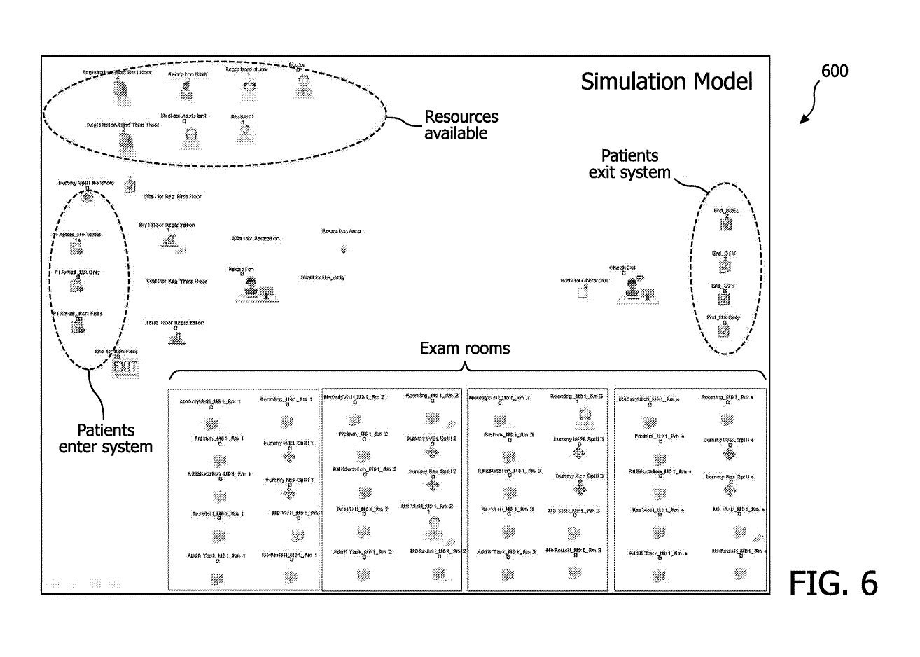

In another approach (not shown), such time slot duplication is not performed. (If this modification were made to the schedule 500 of FIG. 5, the result would be only 19 time slots as the seven duplicate slots would be removed). This avoids the possibility of double-booking a time slot, but increases the likelihood that there will be no patient scheduled in an open access time slot. With reference to FIG. 6, an example simulation model 600 using the input from the hospital healthcare system is described. Simulation optimization model is built to select the optimal template for featured healthcare delivery system. Using general primary care clinic as an example, a discrete event simulation model, including mainly four modules: patient arrival, nurse rooming, physician diagnosis, and nurse discharge, can be established. Simulation software, such as Arena, SIMUL8, ProModel, etc., can be adopted to model such a healthcare delivery system.

In the simulation, patient arrival is generated based on the scheduling template from the candidate templates pool, which specifies the arrival time, visit type, visit length and the designated provider. To incorporate the randomness in arrivals, the deviation of the actual arrival time from the appointment time is captured using probability distributions. Similarly, no-shows and cancellations are modeled to emulate the real arrival. For each arrival generated by the appointment template, there is a certain probability that the patient won't enter into the system conditioning on patient's visit type and slot time, visit length, etc. Same-day appointment visits are also generated according to a probability model, where chances exist that some of the open-access slots are idle for not being booked in advance.

Whether arrived patients are served immediately or wait in line depends on the real-time resource availability. Waiting time for each patient is recorded. For a typical primary care visit, the services mainly consist of nurse rooming, physician diagnosis and nurse discharge. Various services can be added or changed featuring different healthcare delivery systems. The service times for rooming, physician diagnosis, and discharge are characterized with stochastic distributions derived from the operational data database. The service times vary across different patient visit types thus patient's waiting time and length of stay are recorded accordingly. Physician and nurse's workload and utilization are also obtained.

The schedule simulation can be formulated as a multi-objective optimization problem. Some suitable objectives are to maximize physician and other staff's utilization, minimize physician and other staff's working overtime, and minimize patient's waiting time and length of stay, while still satisfying the basic patient demands and provider schedule constraints. To cope with the trade-offs among multiple objectives, a linear scalarization is suitably applied where different objectives are weighted and summed to formulate a single-objective optimization problem so that optimal solutions to the single-objective optimization problem provide optimal solutions to the multi-objective optimization problem.

The optimization problem can be solved in various ways, such as using an optimization module which may be embedded in the simulation package, such as OptQuest in Arena, OPTIMIZ in SIMUL8, and SimRunner in ProModel. The goal of these routines is to seek user-selected system parameters and settings to improve the performance measures of interest. For instance, under each system setting, different templates are used to generate patient arrivals and parameters regarding templates generation (such as probability threshold p) are adjusted within a certain range. Then the simulation results are compared. Prevailing optimization methods like ranking and selection, multiple comparison procedures, ordinal optimization, etc., can be used to elect optimized appointment templates.

With returning reference to FIG. 5 and further reference to hardware of FIG. 1, the optimized patient appointment schedule 500 may be used as follows. The patient appointment schedule 500 is displayed on the display device 112. By interaction via the user interface system 114, a user (e.g. the doctor's office receptionist, a nurse, the doctor, or so forth) may allocate an unfilled time slot to a patient whereby the unfilled time slot is converted to a filled time slot. Conversely, a filled time slot may be deallocated whereby the filled time slot is converted to an unfilled time slot. Time slots which are not designated as open access time slots can be filled (i.e. allocated to a patient) at any time.

On the other hand, the open access time slots are held open until the day of the schedule (or, more generally, until the open access time window starts). The open access time slots can only be allocated (i.e. filled) during the open access time window. With proper optimization of the schedule as disclosed herein, this ensures that a suitable number of open access time slots are available to enable patients who call in on the day of the schedule to be seen that same day.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A medical appointment scheduling system comprising:
a database storing past patient visit log data including at least past patient appointment date and time, and past patient visit outcome information wherein the past patient visit outcome information is at least sufficient to determine whether the past patient was a no show;
one or more electronic processors programmed to generate a patient appointment schedule for an open access time window, the patient appointment schedule comprising time slots, the generating including (1) assigning a no show likelihood for each time slot based on patient no show information retrieved from the database and (2) designating time slots whose no show likelihood exceeds a threshold as open access time slots; and
a user interface system including a display device and at least one user input device, the user interface system configured to:
display the patient appointment schedule,
allocate an unfilled time slot to a patient whereby the unfilled time slot is converted to a filled time slot, and
deallocate a filled time slot whereby the filled time slot is converted to an unfilled time slot,
wherein the user interface system is configured to allocate an unfilled open access time slot to a patient only during the open access time window for which the patient appointment schedule is generated.

2. The medical appointment scheduling system of claim 1 wherein the generating further includes (3) duplicating each open access time slot with the duplicate time slot not designated as an open access time slot, whereby the time interval occupied by each open access time slot can be double-booked by two patients one of which is allocated to the open access time slot during the open access time window for which the patient appointment schedule is generated.

3. The medical appointment scheduling system of claim 1 wherein the database stores the past patient visit log data further including information on medical resources spent on the past patient visit including at least medical personnel time spent on the past patient visit, and the one or more electronic processors is further programmed to:
generate a plurality of different candidate patient appointment schedules for the open access time window; and
choose the patient appointment schedule as the candidate patient appointment schedule that optimizes an objective function computed based on a simulation of the candidate patient appointment schedule.

4. The medical appointment scheduling system of claim 1 wherein the open access time window is a day, and the user interface system is configured to allocate an unfilled open access time slot to a patient only during the day for which the patient appointment schedule is generated.

5. The medical appointment scheduling system of claim 1 wherein assigning a no show likelihood for each time slot includes:
optimizing a predictor function:
ƒ(k,i)=β_{0,k}+β_{1,k}x_{1,i}+β_{2,k}x_{2,i}+ . . . +β_{M,k}x_{M,i}
with respect to past patient visits stored in the database, where i denotes a patient visit, x_{m,i} are patient visit features including at least a feature representing patient appointment date and time, β_{m,k} are coefficients to be optimized, and k is a binary show/no show outcome variable.

6. The medical appointment scheduling system of claim 5 wherein the optimizing comprises performing multinomial logistic regression.

7. The medical appointment scheduling system of claim 1 wherein the one or more electronic processors is programmed to generate the patient appointment schedule for the open access time window further including constraining the time slots based on physician availability during the open access time window as indicated in a physician's calendar.

8. The medical appointment scheduling system of claim 1 wherein:
the generating further includes (3) duplicating each open access time slot with the duplicate time slot not designated as an open access time slot; and
the user interface system is configured to display the patient appointment schedule including an entry for each open access time slot and a separate entry for its duplicate time slot which is not designated as an open access slot.

9. The medical appointment scheduling system of claim 8 wherein the user interface system does not allow user interaction with the displayed entries for the open access time slots except during the open access time window for which the patient appointment schedule is generated.

10. A non-transitory storage medium storing instructions readable and executable by an electronic processor to perform medical appointment scheduling operations including:
generating a patient appointment schedule comprising time slots for an open access time window including designating some time slots as open access time slots;
causing a display device to display the patient appointment schedule including displaying an indication of which time slots are designated as open access time slots;
allocating an unfilled time slot to a patient whereby the unfilled time slot is converted to a filled time slot; and
deallocating a filled time slot whereby the filled time slot is converted to an unfilled time slot;
wherein the allocating is operative for the open access time slots only during the open access time window.

11. (canceled)

12. (canceled)

13. (canceled)

14. (canceled)

15. (canceled)

16. A method for creating a customized appointment scheduling plan with same day appointments available, the method including:
receiving inputs at an electronic processor related to one or more scheduling preferences and historical patient visit data;
generating an appointment template based upon the one or more scheduling preferences;
optimizing the appointment templates based upon the past patient visit data;
creating an optimal schedule; and
displaying the optimal schedule;
wherein the generating, optimizing, and creating are performed by the electronic processor.

17. (canceled)

18. (canceled)

19. (canceled)

20. (canceled)
